(19) United States
(12) Patent Application Publication
(10) Pub. No.: US 2026/0253417 A1
(43) Pub. Date: Aug. 27, 2026

(54) SYSTEMS AND METHODS FOR SMART NOTIFICATIONS AND DATA MANAGEMENT FOR HOME SECURITY SYSTEMS

(71) Applicant: Adeia Guides Inc., San Jose, CA (US)

(72) Inventors: Toshiro Ozawa, Irvine, CA (US); Tao Chen, Palo Alto, CA (US)

(21) Appl. No.: 19/059,846

(22) Filed: Feb. 21, 2025

(51) Int. Cl. G06V 20/40; G06V 10/44; G06V 10/74; G06V 20/70

(52) U.S. Cl. CPC G06V 20/44; G06V 10/44; G06V 10/761; G06V 20/70

(57) ABSTRACT

Methods and systems are presented herein for presenting smart notifications for security systems. An application may receive a first video captured using one or more capturing devices. The application may analyze the first video to determine an event that occurred in the first video, and the application may generate a textual summary describing the event. Based at least in part on the generated textual summary, the application may determine both a criticality level corresponding to the event and a notification corresponding to the event. The notification may be provided for presentation at a device, and the presentation of the notification may be based at least in part on the criticality level.

### BACKGROUND

The present disclosure is directed to systems and methods for smart notifications and data management for home security systems.

### SUMMARY

Security systems have allowed tenants and owners to access information pertaining to events occurring on their designated property, regardless of their physical presence. Security systems, particularly home security systems, may continuously surveille an area and, if an event occurs, send information corresponding to the event to a device, such as a user's phone or personal computer. Home security systems, however, may not always provide substantive information regarding the importance of the event. Whether a routine event or a critical event is captured by a home security system, the same type of notification may be sent to a device or profile with no differentiation in importance indicating whether the captured event was routine or critical. For example, an application of a home security system may send two notifications of the same type (e.g., two notifications both with the text “Someone has Passed by Your Door”) when capturing a first video in which a neighbor walks their dog, and when capturing a second video in which a stranger stole a package. As such, home security systems are often limited in their ability to deliver information indicative of the criticality of an event. Therefore, with the current capabilities of home security systems, it may be difficult to easily differentiate between events which require immediate attention (e.g., a notification related to a burglary) and events which are less significant (e.g., a notification related to routine mail delivery).

In some approaches, a home security system application simply provides notifications whenever an event occurs. In such approaches, a device receiving and displaying the provided notification (e.g., a phone or personal computer) may visually order the event notifications based on the order in which the event notifications were received. For example, a home security system application may provide a first notification corresponding to a burglary at 9:00 AM and then several other notifications corresponding to routine events (e.g., a mail delivery, a jogger passing by, a neighboring car parking nearby, etc.) on the same day as the burglary. Such approaches, however, would visually order the notifications corresponding to routine events before the notification corresponding to the burglary. Despite the burglary being of high criticality, the notification corresponding to the burglary may not be easily viewable, preventing immediate attention to a significant event.

In some approaches, a home security system application allows for the differentiation of the significance of events by providing a notification which specifies where an event occurred. A home security system may include multiple cameras each viewing different areas, a single camera which views multiple areas, or any suitable combination thereof. In such approaches, an application may generate a notification with a description of where an event occurred based on the one or more cameras which recorded the event. For example, a home security system application may send a first notification with the text of “There is someone in your front lawn,” and a later, second notification with the text of “There is someone in your backyard” based on images or video captured by a camera in the front lawn and in the backyard, respectively. Such approaches may be useful in determining the criticality of events if someone is expected to be at the front lawn, and if someone is not expected to be in the backyard; however, such approaches require prior knowledge of when and where certain events are supposed to occur.

In some approaches, a home security system application allows for the differentiation of the significance of events by improving the capturing and recording quality for critical events. In such approaches, if an application of a home security system determines that an event is of high criticality (e.g., grand theft of an automobile), the application may configure one or more recording devices to provide the highest quality of recording for later review. Such approaches, however, still require the manual review of a recording. Manual review may be cumbersome and time consuming if several events are recorded. Storing several recorded events in a highest available resolution may also be storage intensive. Therefore, even with current approaches, there exists a need to provide a straightforward method for differentiating between the significance of events determined by a home security system application and determining which events should have respective videos stored at high quality, low quality, or not stored at all.

To help address these problems, systems, methods, and apparatuses disclosed herein may be configured to provide smart notifications for home security systems. In some embodiments, a home security system application may receive a first video captured using one or more capturing devices. The home security system application may separately receive one or more videos, audio files, pictures, or any suitable data from the one or more recording devices. In some embodiments, a home security system application may analyze the first video to determine an event that occurred in the first video. An event may be anything significant enough to warrant a notification such as an armed burglar entering into a home, a familiar car parking in a driveway, an unknown cat roaming around a front porch, or any other situation which may be of later interest.

In some embodiments, a home security system application may generate a textual summary describing the event. A home security system application may determine a feature in the first video, wherein the feature corresponds to one or more of a person type, an object type, a company type, a profession type, an event type, an action type, a historical event type, or an alert. The home security system application may generate a textual summary that is based at least in part on the feature. For example, one or more features may be indicative that an event had an associated person type of “mail deliverer,” a company type of “United States Postal Service (USPS),” an event type of “mail delivery,” an action type of “package drop-off,” a historical type of “routine,” and an alert type of “non-alert.” As a result, the textual summary generated may be “Mail deliverer from USPS arrived routinely and dropped off a package.” In another example, one or more features may be indicative that an event had an associated person type of “thief,” a company type of “unknown,” an event type of “package theft,” an action type of “stealing,” a historical type of “non-routine,” and an alert of “high alert.” As a result, the textual summary generated may be “unknown thief stole package.” In some embodiments, if it is determined that multiple packages have been stolen, then an alert feature may be more descriptive (e.g., “high alert, multiple package thefts”) and the resulting textual generated may instead be “unknown thief has stolen multiple packages in the neighborhood.”

In some embodiments, the home security system application may determine a criticality level corresponding to an event, wherein the criticality level is based at least in part on one or more of a textual summary or information corresponding to an event. Determining a criticality level corresponding to an event may further comprise, based on determining that the event corresponds to a predetermined event from an external application, determining that the event corresponds to a non-threat. For example, the external application may be an online calendar, and the predetermined event may be a plumbing appointment. As such, upon a home security system application determining that received video is of an event where a plumber is knocking on a door and upon determining that there is a coinciding plumbing appointment on a calendar application, the event may be considered a non-threat. Additionally, determining a criticality level corresponding to an event may further comprise, based on determining that the event corresponds to a routine event, determining that the event corresponds to a non-threat. For example, mail may be routinely delivered on Mondays at approximately 10:00 AM. As such, upon a home security system application determining that a received video is of a mail delivery event on a Monday at 10:03 AM and upon determining that mail delivery on Monday at approximately 10:00 AM is routine, the event may be considered a non-threat.

A home security system application may additionally receive feedback information, wherein the feedback information comprises information indicative of an accuracy of one or more of a textual summary, a criticality level, or a feature. The home security system application may analyze the feedback information in a later analysis of a second received video. For example, if a textual summary states “A stranger walked their dog by your front porch,” a home security system application may receive feedback information indicating that the person identified was actually a resident of the neighborhood instead of a stranger. As a result, a textual summary of the same event occurring in the future may state “A neighbor walked their dog by your front porch.”In some embodiments, a home security system application may determine a notification based on a textual summary, wherein a presentation of the notification is based at least in part on a criticality level. For example, if a home security system application generates a textual summary stating “HIGH ALERT. An unknown armed burglar entered your home!” and determines a high criticality level, a notification may include the textual summary with red, bolded font with certain words of the textual summary highlighted. Alternatively, if a home security system application generates a textual summary stating “John (Dad) is watering plants” and determines a low criticality level, a notification may include the textual summary with a neutral color and no other annotations. In some embodiments, a presentation of a notification need not be visual. For example, a notification may be an audio message.

In some embodiments, a home security system application may provide a notification for presentation at a device. In some embodiments, a device need not be associated with a greater home security system and may be an external device such as a phone with a profile linked to the greater home security system. A home security system application may determine that a prior notification was generated for display at a device based on a prior event and determine a display order of the notification and the prior notification, wherein the display order is based at least in part on a criticality level corresponding to the (e.g., most recent) event and a second criticality level corresponding to the prior event. The home security system application may transmit to the device information indicative to order the prior notification and the notification based on the display order. For example, if an event, which was more recent, was determined to be of lower criticality than a prior event, which already had a corresponding notification sent to a device, a home security system application may send an indication to the device to visually order the notification corresponding to the prior event higher than notification corresponding to the most recent event.

In some embodiments, videos which a home security system application receives may be stored at a non-transitory computer readable medium for later analysis, manual review, or any other suitable purpose. A home security system application may, based at least in part on a criticality level, determine a resolution quality level for a first video and store the first video at the resolution quality level. For example, recorded videos of events with a high corresponding criticality level may be stored at a higher resolution than events with a low corresponding criticality level. Storage may occur on a local device which may be part of a greater home security system, on a remote server in a cloud-based infrastructure external to a greater home security system, or any other suitable storage medium.

In some embodiments, a home security system application may retrieve a previous video from a server, wherein the previous video was previously captured and corresponds to a previous event. The system application may determine a similarity confidence level, wherein the similarity confidence level comprises information indicative of whether the previous event corresponding to the previous video is similar to the event corresponding to a first (or otherwise most recent) video. The home security system application may determine that the similarity confidence level exceeds a similarity threshold and, in response to determining that the similarity confidence level exceeds the similarity threshold, delete the previous video from the server. For example, if an event is similar to a previous event, such as the same delivery person delivering packages on two different occasions, a home security system application may determine that the two events have a high similarity confidence level. Only one of the videos may be needed in the future for reference, so a home security system application may delete whichever video was older of the two similar videos (e.g., for the purposes of storage or memory management).

Alternatively, the system may determine instead to simply not store the more recent video, and maintain the storage of the previous video, with an entry indicating that a similar event occurred at a later time corresponding to the more recent video. In some embodiments, a home security system application may determine that a first video corresponds to a high criticality level, wherein the high criticality level is a type of criticality level, and annotate the first video with a flag, wherein the flag indicates to not delete the first video. For example, a video of an event where a suspicious, unknown person steals a package may correspond to a high criticality level, so the video may be annotated with a flag indicative of metadata indicating that the video should not be deleted or at least that extra review is required before deletion.

In some embodiments, a home security system application may determine that a first video was captured using a first device from one or more capturing devices. The home security system application may transmit an indication to a second device from one or more capturing devices. The indication may cause the second capturing device to capture video at a high resolution. If a first device captures a video of an event, then it may be desirable for a second device to record in a higher quality (e.g., in anticipation of being able to capture meaningful video). Causing the second device to capture video at a high resolution may be especially useful when reviewing video to determine particular individuals (e.g., in the case of a burglary investigation where identifying individuals is required).

Therefore, such aspects related to the disclosure of this invention alleviate the issue of being unable to easily differentiate between events which require immediate attention and events which are less significant. The present disclosure enables an invention which provides an informative notification to a device such that the notification clearly provides information indicative of whether immediate attention is required regarding an event. As such, notifications may more clearly display relevant information and only require brief review to determine which notifications correspond to events of high criticality.

Aspects of the present disclosure also improve upon capabilities of current home security systems with respect to how recorded events are stored. For example, rather than simply storing videos of general surveillance and videos of significant events in the same manner, aspects of the invention ensure that events of high criticality are captured at resolutions well suited for later review. In another example, videos of events of high criticality are annotated such that extra review is required before deletion.

Notably, the present invention is not limited to the combination of the elements as listed above and may be assembled in any combination of the elements as described herein.

These and other capabilities of the disclosed subject matter may be more fully understood after a review of the following figures, detailed description, and claims.

### BRIEF DESCRIPTIONS OF THE DRAWINGS

The present disclosure, in accordance with one or more embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration these drawings are not necessarily made to scale.

The embodiments herein may be better understood by referring to the following description in conjunction with the accompanying drawings in which like reference numerals indicate identically or functionally similar elements, of which:

FIG. 1 shows a scenario of a security system application providing a notification to a device corresponding to an event of high criticality, in accordance with some embodiments of the disclosure;

FIG. 2 shows a scenario of a security system application providing a notification to a device corresponding to an event of low criticality, in accordance with some embodiments of the disclosure;

FIG. 3 is an illustrative diagram which shows how a security system application manages storage of previous videos, in accordance with some embodiments of the disclosure;

FIG. 4 is an illustrative scenario which shows how a security system may cause different capturing devices to capture media at different resolutions, in accordance with some embodiments of the disclosure;

FIG. 5 is an illustrative sequence diagram which shows how notifications may be generated by a security system application upon the determination that an event is occurring, in accordance with some embodiments of the disclosure;

FIG. 6 depicts a communication system which may be used in a home security system application, in accordance with some embodiments of the disclosure; and

FIG. 7 is an illustrative flowchart outlining the steps for a method which provides a notification for an event, in accordance with some embodiments of the disclosure.

The drawings are intended to depict only typical aspects of the subject matter disclosed herein, and therefore should not be considered as limiting the scope of the disclosure. Those skilled in the art may understand that the structures, systems, devices, and methods specifically described herein and illustrated in the accompanying drawings are non-limiting exemplary embodiments and that the scope of the present invention is defined solely by the claims.

### DETAILED DESCRIPTION

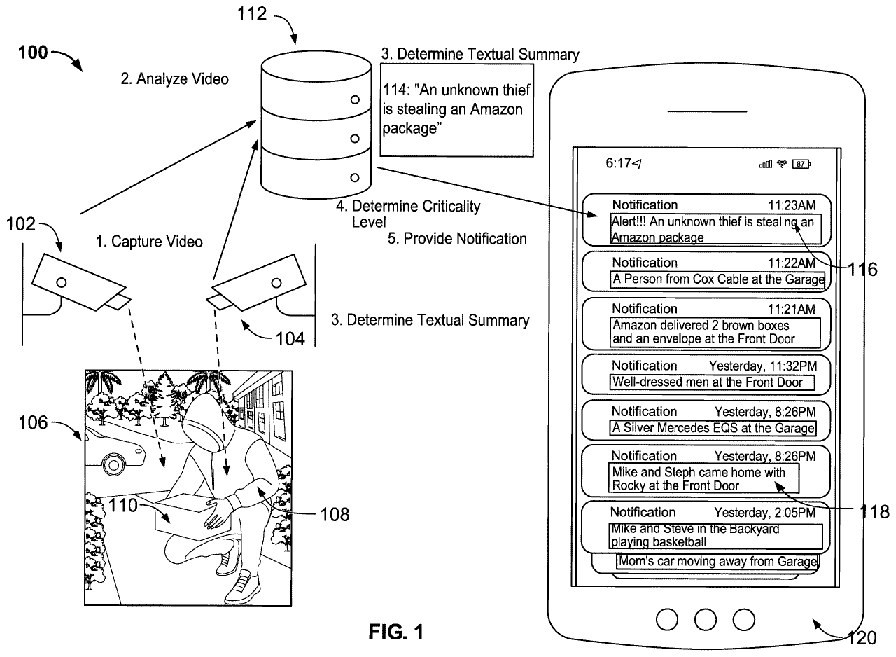

FIG. 1 shows scenario 100 of a security system application providing a notification to a device corresponding to an event of high criticality, in accordance with some embodiments of the disclosure.

In FIG. 1, capturing device 102 and capturing device 104 capture media 106. It should be understood that more or fewer than two capturing devices may be present and capturing event 106. Furthermore, capturing devices 102-104 may capture one or more of audio, video, thermal signatures, temperature, or any suitable combination thereof which correspond to captured media 106. Captured media 106 includes a video of thief 108 stealing package 110. Capturing device 102 and/or capturing device 104 transmit captured media 106 (e.g., which may include one or more video recordings) to server 112 for further processing. Server 112 may be a decentralized cloud server, centralized computing server, edge node server, local computing server, or any suitable combination thereof.

Server 112 is encoded with or receives instructions that when executed analyze captured media 106 to determine an event corresponding to captured media 106. Although various features have been described as being performed by the server 112, in some embodiments, one or more of these features may instead be performed by one or more of the capturing devices (e.g., 102, 104) or another computing device communicatively coupled to the capturing devices. The analysis performed by server 112 may produce results which include outputs from one or more of a general video processing technique, artificial intelligence (AI) program (e.g., for computer vision (CV)), audio analysis (e.g., Fourier transform or signal processing), queries from external applications, queries related to metadata, other subroutines, or any suitable combination thereof as further described hereafter.

In some embodiments, server 112 may analyze captured media 106 with a general video processing method. A general video processing method may include edge detection. For example, server 112 may analyze media 106 to find certain image frames which include particular discontinuities in brightness. As a result of the discontinuities, server 112 may determine that a particular figure corresponds to thief 108 and that a particular object corresponds to package 110 within media 108. General video processing techniques may be supplemented with AI as further described below.

In some embodiments, server 112 may analyze captured media 106 with AI. Analysis performed by server 112 which uses AI may include, but is not limited to, results from a convolutional neural network (CNN) specifically trained for CV purposes. A CNN employed by server 112 may be trained using previous videos captured using capturing devices 102-104, previous videos captured using other capturing devices, or any suitable combination thereof. Other CV techniques may be based on rule-based patter matching, edge detection, object tracking, color analysis, or movement analysis. CV techniques may be implemented using deep learning or other generalized uses of supervised, unsupervised, or semi-supervised learning.

In some embodiments, server 112 may use the results of an AI analysis to determine an event which occurred in media captured by capturing devices 102-104. For example, a CNN may determine that in captured media 106, thief 108 is stealing package 110. The CNN may determine that event 106 is a “package theft” event. The CNN may also determine specific objects in media received from capturing devices 102-104 such as package 108.

In some embodiments, server 112 may perform an audio analysis (e.g., via Fourier transform or other signal processing methods) to analyze captured media 106. For example, a Fourier Transform maybe executed to break down the captured audio into specific components which may correspond to sounds associated with a high criticality level. Sudden loud noises (e.g., booms, thuds, or yells) typically have certain frequency patterns that may be easily identified as frequency patterns associated with a high criticality level. The server may use AI in conjunction with traditional signal processing methods to analyze captured media 106. Other forms of audio analysis which server 112 may perform include spectrogram generation (e.g., to analyze pitch variations over a certain time domain), spectrum analysis (e.g., to determine the different frequencies which may exist in audio-based media), or other methods of audio feature extraction.

In some embodiments, server 112 may analyze captured media 106 by querying external applications. For example, a calendar application may include specific details of when certain events are expected to occur. In an example, the calendar application may include information such as “plumber expected at 1:30 PM on Sunday,” “repair worker expected at 3:30 PM on Sunday,” “mail package expected at 10 AM on Tuesday,” or “dog walker expected at 11:30 AM on Wednesday.” As such, server 112 may determine that captured media 106 does not correspond to any expected events.

In some embodiments, server 112 may query metadata associated with captured media 106. For example, queried metadata may include information regarding the time of day during capture, temperature during capture, frame rate of capture, any other related information to the capture, or any suitable combination thereof. Metadata indicative of captured media originating from non-typical business hours (e.g., hours outside of 9 AM to 5 PM) may suggest that an event corresponding to captured media is of high criticality.

In some embodiments, server 112 may be encoded with or receive instructions that when executed run at least one subroutine corresponding to a personal object recognizer, video indexer, or event classifier. Server 112 may execute a subroutine corresponding to a personal object recognizer to determine the type of person or persons in the event. For example, a subroutine corresponding to a personal object recognizer, when executed, may determine for captured media 106 that thief 108 is not a recognized person and may classify thief 108 any one of type “thief,” “unfriendly person,” or “suspicious person.” Server 112 may execute a subroutine corresponding to a video indexer to determine a description. For example, a subroutine corresponding to a video indexer, when executed, may determine a type of event such as “package theft.” Server 112 may execute a subroutine corresponding to an event classifier to determine a whether the event should be considered significant. For example, a subroutine corresponding to an event classifier, when executed, may determine that the event is an abnormal event (e.g., based on a number of occurrences, or a likelihood of occurrence) which may require immediate attention. Any one of the personal object recognizer, video indexer, or event classifier subroutines may incorporate results from AI-based algorithms and/or audio analysis.

The analysis performed by server 112 which may include results from one or more of artificial intelligence (AI), Fourier transform or signal processing methods, queries from external applications, queries related to metadata, other subroutines, or any suitable combination thereof may ultimately be used to determine an event which corresponds to captured media 106. For example, server 112 may determine that the event in captured media 106 is an event not anticipated by an external application such that an unknown person that is likely a thief is stealing a package.

Server 112 may generate textual summary 114. Textual summary 114 may be a concise explanation of the event which encapsulates relevant components of the analysis performed by server 112. Textual summary 114 may be generated using one or more deep learning models. For example, server 112 may utilize the results from a transformer-based model utilizing an attention mechanism, such as a large language model (LLM), to generate textual summary 114. Reinforcement learning from human feedback (RLHF) may also be used to improve the accuracy and precision of textual summary 114 with respect to an event. In an example where server 112 utilizes the results of an LLM to generate textual summary 114, feedback may be provided indicating whether textual summary 114 was accurate as a binary indicator, score system, textual comment, or any suitable combination thereof. The feedback may be used to provide better textual summaries in the future. In another example, server 112 may utilize the results from a generative adversarial network (GAN) to generate textual summary 114. Other suitable text generation programs may be used to generate textual summary 114.

Server 112 may determine a criticality level corresponding to an event. A criticality level corresponding to an event may be determined based at least in part on a generated textual summary or other information corresponding to the event. In some embodiments, the criticality level need not be determined using both a generated textual summary (e.g., textual summary 114) and information corresponding to the event; a criticality level may be determined with different factors independently as further described hereafter.

A criticality level may be based on a generated textual summary corresponding to an event. For example, a textual summary 114 for an event occurring in captured media 106 may be “an unknown thief is stealing an Amazon package.” Due to the mention of the words “unknown” and “stealing,” a high criticality level may be determined. In another example, a generated textual summary for an event may be “a neighbor is walking their dog.” Due to the mention of the words “neighbor,” “walking,” and “dog,” a low criticality level may be determined for the event. A named entity recognition (NER) algorithm may be utilized to determine specific words which may be relevant for determining a criticality level. Relevant words may also be extracted from any one of the results from a personal object recognizer, video indexer or event classifier as previously discussed.

A criticality level may be based on information corresponding to an event, in addition to or instead of the textual summary. For example, the criticality level may be determined at least in part based on image analysis, audio analysis, and/or other information pertaining to the event which is not included in the textual summary (e.g., calendar information). Information corresponding to an event may be related to information which resulted from analyzing captured media to determine an event which occurred in the captured media. For example, a CNN may have determined that thief 108 was in captured media 106, a signal processing method may indicate that thief 108 loudly stole package 110 (e.g., via analysis of the audio of the captured media 106), and a query from a calendar application may indicate that no prelisted event was expected to occur at the time captured media 106 was recorded. Based on the information corresponding to the event (e.g., the audio indicating a package was taken and the calendar indicating that no delivery was expected), which may or may not have been used to determine an event which occurred in captured media 106, server 112 may determine a high criticality level for the event.

In some embodiments, server 112 may determine a criticality level using either or both a generated textual summary or information corresponding to an event. Server 112 may be encoded with or receive instructions to consider the textual summary and information corresponding to an event with varying levels of importance. For example, textual summary 114 may be considered significantly more important in determining a criticality level compared to information corresponding to an event. In another example, textual summary 114 may not be considered at all when determining a criticality level. Server 112 may be encoded with or receive instructions indicating to use preset weights for determining the significance of certain types of information when determining a criticality level. Instructions may instead indicate to use an AI algorithm (e.g., random forest, decision tree, linear regression) to determine a criticality level with features based on textual summary 114 or information corresponding to the event.

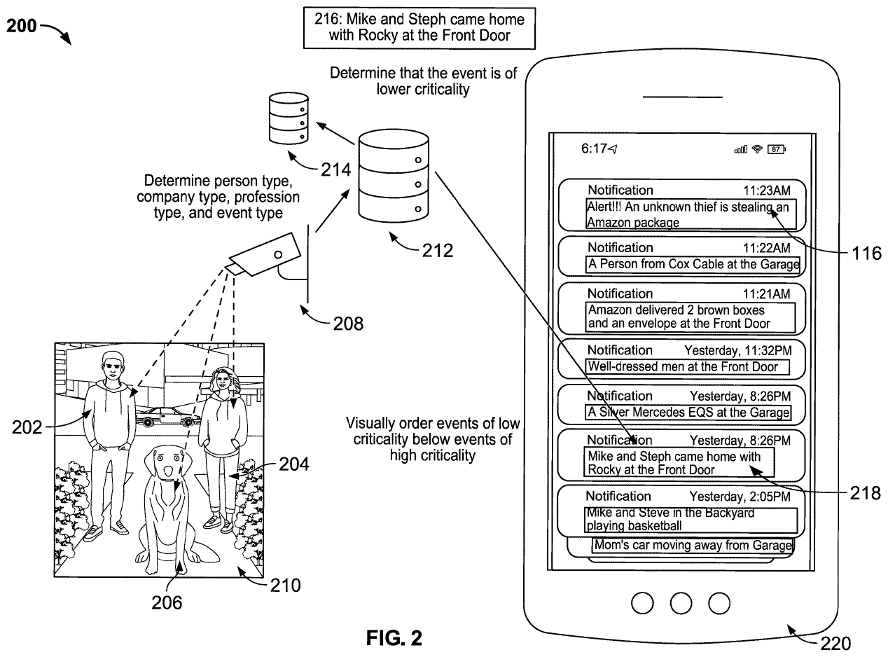

Server 112 may determine a presentation of notification based on a textual summary. A presentation of a notification (e.g., the order of presentation of notifications, the visual characteristics of a notification or part of a notification, the timing of the presentation of a notification, etc.) may be based at least in part on a criticality level. Notification 116 corresponding to captured media 106, may include textual summary 114. Based on determining that captured media 106 corresponds to a high criticality level, notification 116 may have different colors for different words. For example, for textual summary 114 stating “an unknown thief is stealing an Amazon package,” the words “unknown,” “thief,” and “stealing” may be in a deeper color (e.g., red) than other words in textual summary 114 such as “an” or “is.” Moreover, notification 116 may include words additional to textual summary 114 based on a criticality level. For example, for notification 116, because a high criticality level was determined, additional text saying “Alert!!!” may be shown with textual summary 114. If an event in captured media 106 instead corresponds to a low criticality level (e.g., as described below in FIG. 2), a notification may use the same color for all the words that are mentioned. For example, notification 118 may correspond to an event of low criticality. Notification 118 may include text stating “Mike and Steph came home with Rocky at the front door” such that all the words are in the same color. As such, less attention may be drawn to notification 118 instead of notification 116 because notification 118 may have more attention drawing features.

Server 112 may provide a notification for presentation at a device. For example, notification 116 and notification 118 may be transmitted to device 120 for presentation. Device 120 may be a phone, laptop, tablet, any device capable of receiving and/or presenting notifications, or any suitable combination thereof. A notification may be transmitted to a central database housing information related to different accounts. These different accounts may be associated with owners or members of a home security system application capable of executing instructions that perform the operations discussed in this disclosure. Upon transmitting a notification to a central database, an additional server (which may be the same as server 112) or instructions encoded on a particular device may cause a notification to be presented at the particular device (e.g., device 120).

In some embodiments, a particular order may be determined for different notifications. For example, server 112 may determine that notification 116 is an event of high criticality and that notification 118 is an event of low criticality. This determination may cause notification 116 to be presented before, higher than, or more prominently (e.g., brighter, flashing, etc.) than notification 118 in order to draw more attention to notification 116.

In some embodiments, certain notifications need not be provided for display at device 120. For example, a notification corresponding to an owner of a home checking their mailbox need not be provided for presentation at device 120. In some embodiments, notifications which were determined to originate from events which corresponded to an external application need not be necessarily provided at device 120. For example, if an event corresponds to a plumber knocking on a door, and a corresponding plumbing appointment is found to exist at an external application, the notification for the event need not necessarily be provided at device 120.

FIG. 2 shows scenario 200 of a security system application providing a notification to a device corresponding to an event of low criticality, in accordance with some embodiments of the disclosure. It should be appreciated that while embodiments are described herein with reference to a home security system, the same functions, features, and principles may also be applied to a business security system, or any other security system having the necessary components described in this disclosure.

In scenario 200, individual 202, individual 204, and animal 206 may be captured by capturing device 208. Capturing device 208 may capture (e.g., by recording) media 210. It should be understood that reference to capturing device 208 may also be in reference to capturing devices 102-104. Capturing device 208 may transmit media 210 to server 212 for further processing.

Server 212 may perform an analysis on media 210 to determine certain features or characteristics that may be relevant in producing a corresponding notification. It should be understood that reference to server 212 may also be in reference to server 112. Server 212 may perform any of the same functions as 112 as described in connection with FIG. 1.

In some embodiments, server 212 may utilize one or more of a personal object recognizer, video indexer, or event classifier subroutine (e.g., as described above in connection with FIG. 1) to analyze media 210. For example, personal object recognizer may perform a facial recognition analysis to determine the identity of one or more of individual 202, individual 204, or animal 206. Facial recognition may be performed by utilizing results from a principal component analysis, CNN, region-based CNN (r-CNN), or any other suitable framework or algorithm. A personal object recognizer may determine that individual 202 and individual 204 correspond to recognized individuals, e.g., individuals named Mike and Steph, respectively. A personal object recognizer may also determine that animal 206 may correspond to a recognized animal, e.g., a dog named Rocky. A personal object recognizer may determine that certain individuals or animals correspond to known individuals or animals based on information held in a stored database. For example, database 214 may store compressed or uncompressed data which may be used to identify individuals or animals. The data which database 214 stores may be from previously captured media or may be based on information submitted to a home security system application (e.g., by a user).

In some embodiments, a personal object recognizer subroutine may determine other information relevant to identifying an individual or animal in received media. For example, individual 202, individual 204, and animal 206 do not have any indicia indicating that they are members of a particular organization or company. In a different scenario, media received at server 212 may feature a plumber from a company called “Best Plumbers Around,” and the plumber may be wearing an article of clothing with indicia indicating that they are a member of the “Best Plumbers Around” company. As a result of the visible indicia, server 212 may determine that the person in the aforementioned scenario is a member of the “Best Plumbers Around” company, and that the person in the aforementioned scenario is a plumber. In another scenario, media received at server 212 may feature a mail deliverer from the United States Postal Service, and the mail deliverer may be wearing an article of clothing with indicia indicating that they are a member of the United States Postal Service. As a result of the visible indicia, server 212 may determine that the person in the aforementioned scenario is a member of the United States Postal Service, and that the person in the aforementioned scenario is a mail deliverer. Moreover, server 212 may access database 214, the Internet, or any other source of information which may be suitable for determining the identity of individuals or animals in received media.

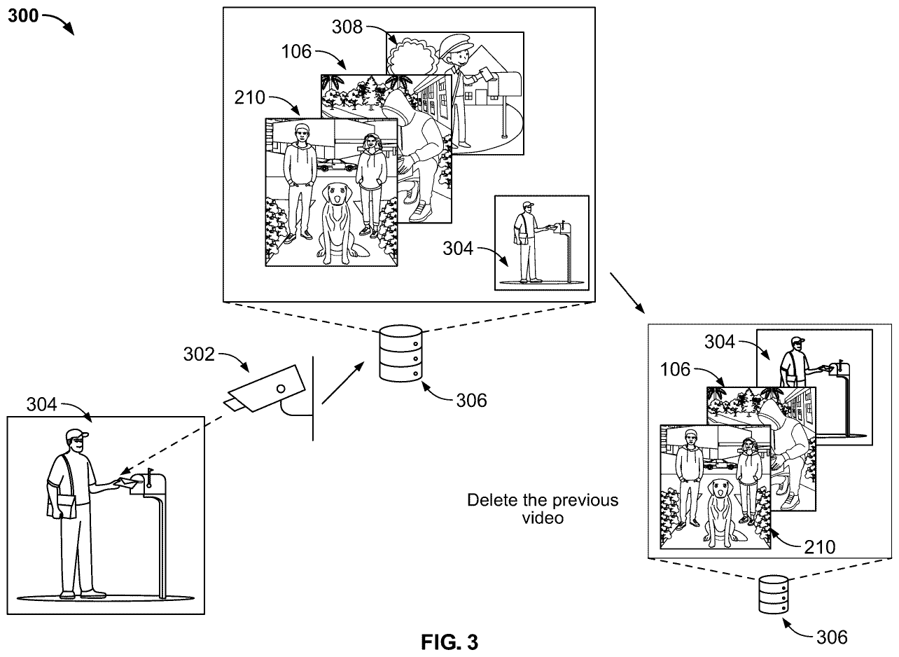

In some embodiments, server 212 may utilize a video indexer subroutine to return a brief or generic description. For example, a video indexer subroutine may determine a brief description of “A man, a girl, and a dog are at the Front Door.” The brief description of “A man, a girl, and a dog are at the Front Door” may be used when determining if certain videos with similar brief descriptions should be deleted or not (e.g., as discussed below in FIG. 3).

In some embodiments, server 212 may utilize an event classifier subroutine to determine if the event is normal or abnormal. Server 212, by an event classifier, determines that the event corresponding to media 210 (i.e., an event of familiar individuals returning home with a familiar dog) is a normal event. The event classifier may determine that the event corresponding to media 210 is a normal event based at least in part on the individuals identified from a personal object recognizer or a brief description generated by an event indexer. The event classifier may, in addition to or in place of, determine that the event corresponding to media 210 is a normal event by performing any of the previous analyses described in connection with FIG. 1.

Server 212 may generate a textual summary 216 corresponding to the event of media 210. For example, server 212 may generate textual summary 216 stating, “Mike and Steph came home with Rocky at the Front Door.” As described in connection with FIG. 1, server 212 may utilize the results from a transformer-based model to generate textual summary 216 and may also use RLHF to better improve the accuracy of and precision of textual summary 216 with respect to an event.

Server 212 may determine a criticality level corresponding to an event. As described in connection with FIG. 1, a criticality level corresponding to an event may be determined based at least in part on a generated textual summary or other information corresponding to the event. For example, server 212 may determine that the event corresponding to media 210 is an event of low criticality because textual summary 216 mentioned the words “Mike,” “Steph,” and “Rocky.” The words “Mike,” “Steph,” and “Rocky” may indicate that the individuals arriving at the front door are all recognized individuals, and therefore the event is of low criticality. In another example, server 212 may utilize the results of a personal object recognizer, video indexer, or event classifier. A personal object recognizer may determine that the individuals in media 210 are familiar, and an event classifier may determine that the event in media 210 is a normal event. As a result, server 212 may determine that the event is of low criticality. Server 212 may determine the critical level of an event using a combination of any previous analyses (e.g., results from a personal object recognizer, video indexer, or event classifier) or a generated textual summary.

Server 212 may provide notification 218 to device 220. It should be understood that reference to device 220 may also be in reference to device 120. Notification 218 may include textual summary 216. Due to the event of media 210 having a low criticality level, notification 218 may feature the text of textual summary 216 in white font with minimal markings and other non-visually prominent indicia.

In some embodiments, the ordering of notifications is based at least in part on their corresponding criticality levels. A home security system application may determine that a prior notification is generated for display at the device based on a prior event. For example, the home security system application may determine that notification 116 has already been generated for display at device 220. The home security system application may determine a display order for notification 116 and notification 218 such that the display order is based at least in part on the corresponding criticality levels for each notification. The home security system application may transmit information indicative of an order for notification 116 and notification 218. For example, if notification 116 and notification 218 are displayed on device 220, notification 116 may be displayed more prominently compared to notification 218. Notification 116 may be displayed more prominently because notification 116 corresponds to an event of higher criticality than the event which notification 218 corresponds to.

Notification 116 may be displayed more prominently than notification 218 in a plurality of ways. For example, notification 116 may be displayed closer to the top of a screen compared to notification 218 as seen in scenario 200. In another example, notification 116 may dynamically change presentation while notification 218 is presented statically. Notification 116 may dynamically change presentation by flashing, blinking, changing colors, changing font types, changing font sizes, or by changing highlighted regions (e.g. at the end of a configured time period). Meanwhile, notification 218 may keep the same aesthetic attributes (e.g., color, font types, font size, highlights) from the time it was initially presented. In yet another example, notification 116 may take up a larger area on device 220 compared to notification 218.

In some embodiments, notifications may be audio based. In the case where notifications are audio based, notifications corresponding to events of lower criticality may be projected at a “normal” audio level. Notifications corresponding to events of higher criticality may be projected at a “louder” audio level such that the “louder” audio level is at a higher decibel level than the “normal” audio level. In some embodiments, the tone of voice for notifications corresponding to events of high criticality may be sterner than for notifications corresponding to events of low criticality. Settings for how an audio-based notification system operates (e.g., specific parameters) may be updated continuously.

In some embodiments, if the criticality level corresponding to a particular notification is low, then the particular notification need not be presented. Regarding scenario 200, because notification 218 corresponds to an event of low criticality, device 220 may be configured such that notification 218 is not presented. In some embodiments, notifications corresponding to events which are anticipated or otherwise predetermined need not be presented on a device if the device is configured accordingly. For example, if an event corresponds to an anticipated gardening appointment (e.g., corresponding to a gardening appointment scheduled on an external calendar application), then a notification corresponding to the anticipated gardening appointment need not be presented on a device. In some embodiments, notifications corresponding to events which are routine need not be presented on a device if the device is configured accordingly. For example, if an event corresponds to a routine garbage collection, then a notification corresponding to the routine garbage collection need not be presented on a device. A device may be configured such that notifications corresponding to anticipated and/or routine events are never, sometimes, or always presented.

FIG. 3 is an illustrative diagram 300 which shows how a security system application manages storage of previous videos, in accordance with some embodiments of the disclosure. When recently captured media (e.g., media 106, 210) is transmitted to a server (e.g., server 112, 212) for processing (e.g., which may include any of the analyses as described in connection with FIGS. 1-2), the server determines whether or not the captured media should be stored for later use. For example, media 106 may be more relevant for later use compared to other media which corresponds to events of low criticality (e.g., events that are routine or are anticipated by a calendar application). It may be desirable to later review media 106 in an effort to determine the identity of thief 108. Moreover, it may be desirable for a server to later reference media 106 when determining a criticality level for a future event (e.g., as part of a facial recognition analysis). In contrast, media which corresponds to an event which occurs routinely (or media which otherwise corresponds to an event of low criticality) is unlikely to be reviewed at a later date. As a result of the media being unlikely to be later reviewed, it may be desirable (e.g., for the purposes of storage optimization) to replace previously existing similar media with more recent media, to only store some aspect of the media, to store a lower quality version of the media, or to not store the media as further described below.

In diagram 300, capturing device 302 captures media 304 and transmits media 304 to database 306. It should be understood that reference to capturing device 302 may also be in reference to capturing devices 102-104 or 208. It should be understood that reference to database 306 may also be in reference to database 214. Database 306 may contain one or more previous media information corresponding to one or more captured events. In diagram 300, database 306 contains previous media 106, 210 and 308 in addition to media 304. Media 308 is similar to media 304 and both media correspond to an event of low criticality (i.e., an event such that a mail deliverer is delivering mail). Media 308 may have been stored in database 306 earlier than media 304.

In some embodiments, in order to efficiently manage storage, a home security system application may delete one of either previously stored media or more recent media if previously stored media and recent media are determined to be similar. For example, the home security system application may be configured to delete previously stored media and save more recent media. The home security system application may retrieve previous media (e.g., a video, image, written text description, or other metadata) from a database such that the previous media corresponds to a previous event. For example, a home security system application may retrieve previous media 308 which corresponds to a previous routine event (i.e., a previous and routine mail delivery). A home security system may determine a similarity confidence level such that the similarity confidence level includes information indicative of how similar given media is compared to a previously stored media. For example, a home security system application may determine a high similarity confidence level between media 304 and media 308. If a determined similarity confidence level exceeds some similarity threshold, then the home security system application may delete the previous similar video. For example, if the home security system application determines that the similarity confidence level between media 304 and media 308 is higher than some threshold, then the home security system application may delete media 308. Hence, database 306 may be updated to only contain media 106, 212 and 304. A home security system application may also be configured to instead delete recent media 304 and retain previous media 308. As a result, database 306 may stay unmodified to only contain media 106, 212, and 308.

In some embodiments, when a home security system application deletes previously stored media because more recent media is similar, the home security system application may determine a similarity confidence level between two articles of media by performing certain analyses. For example, the home security system application may use deep learning models (e.g., CNNs) to determine if media 304 and media 308 are similar. In another example, the home security system application may determine if the audio between media 304 and media 308 are similar. To determine if two articles of audio are similar, spectrograms, mel-frequency cepstral coefficients, or any suitable feature for the two articles of audio may be compared. In yet another example, the home security application may generate embeddings for each of media 304 and media 308 and compare the embeddings to determine a similarity confidence level. To generate embeddings, autoencoders may be used to determine compressed representations for each audio. To compare embeddings, the Cosine similarity, Euclidean distance, or any other suitable distance metric may be used to determine how similar each audio is.

In some embodiments, when a home security system application deletes previously stored media because more recent media is similar, the home security system application need not determine a similarity threshold per se. For example, a similarity confidence level may be a binary indicator (e.g., 1 to indicate that two articles of media are similar and 0 to indicate that two articles of media are different). As a result, when the home security system application is determining if the similarity confidence level exceeds the similarity threshold, the home security system application may instead determine what the binary indicator is for the two articles of media. Regarding scenario 300, the similarity confidence level between media 304 and media 308 may be “1.” As a result, the similarity confidence level of “1” indicates that media 304 and media 308 are similar to an extent such that only one of either media 304 or media 308 may be required for future review.

In some embodiments, in order to efficiently manage storage, a home security system application may only store some aspect of the previously stored media, the recent media or both. Regarding diagram 300, if the home security system application determines that media 304 and media 308 have a similarity confidence threshold that exceeds a similarity threshold, then the home security system application may only store some aspect of either media 304, media 308, or both. For example, the home security system application may only store a description (e.g., a textual summary or a brief description from a video indexer) for media 304, media 308, or both. In another example, the home security system application may only store generated embeddings for media 304, media 308, or both. After only some aspect of the previously stored media (e.g., media 308), the recent media (e.g., 304), or both have been stored in database 306, the home security system application may delete whichever media article did not have only some aspect stored. For example, if only a brief description (e.g., generated by a video indexer subroutine) was stored for media 304, then media 308 may be deleted.

In yet another example, the home security system application may store media 304, along with an entry for media 308 (e.g., the time that media 308 was captured), in order to create a list of all the captured events that are similar to media 304. The list of entries corresponding to media 304 may expand as additional similar media is captured, such that only one copy of media 304 is stored and respective entries are created and associated with the stored media for each subsequent similar event occurrence.

In some embodiments, in order to efficiently manage storage, a home security system application may only store a lower quality version of the previously stored media, the recent media, or both. Regarding diagram 300, if the home security system application determines that media 304 and media 308 have a similarity confidence level that exceed a similarity threshold, then the home security system application may store media 304, media 308, or both in a lower quality. For example, media 308 may be a video in 1080p. After determining that media 304 and media 308 have a similarity confidence level which exceed a similarity threshold, media 304 may instead be stored at 144p.

In some embodiments, in order to efficiently manage storage, a home security system application may not store any recent media which is similar to previous media. Regarding diagram 300, if the home security system application determines that media 304 and media 308 have a similarity confidence level that exceed a similarity threshold, then the home security system application may not store any portion of media 304. Due to media 304 being similar to media 308, media 308 may be suitable for later analysis; hence, it may be unnecessary to store media 304.

In some embodiments, in order to efficiently manage storage, a home security system application may determine a quality in which to store captured media based on its criticality. For example, the home security system application may determine that media 304 corresponds to an event of low criticality. In response to determining that media 304 corresponds to an event of low criticality, the home security system application may store media 304 in a lower quality (e.g., if media 304 is a video). Media 304, corresponding to a mail delivery event, may be anticipated by an external application (e.g., a calendar application). That is, the external application may already have a scheduled mailing event which corresponds to media 304. Media 304 may also or instead be considered to be a routine event. For example, the home security system application may determine a particular time or day of the week which mail deliveries typically occur. If media 304 corresponds to the determined times or days which a mail delivery may occur, then media 304 may correspond to an event of low criticality because the corresponding event was determined to be routine. The home security system application (e.g., based on determining that media 304 is a routine or an anticipated event) may otherwise determine that media 304 corresponds to an event of low criticality, and consequently store media 304 in a lower quality (e.g., in 144p instead of 1080p).

In some embodiments, in order to efficiently manage storage, a home security system application may annotate media with a particular flag indicating that the corresponding media should not be deleted. For example, media 106 corresponds to an event of high criticality. It may be desirable to review media 106 (e.g., for the purposes of identifying thief 108 or to be used as reference for a deep learning analysis). As a result of media 106 potentially being of high value at a later date from its capture, the home security system application may annotate media 106 with a flag such that the flag indicates that media 106 should not be deleted. The home security system application may additionally or instead annotate media 106 with a flag indicating that media 106 should not be altered in storage (e.g., in database 306) such that only an aspect of media 106 or a lower quality version of media 106 may be stored.

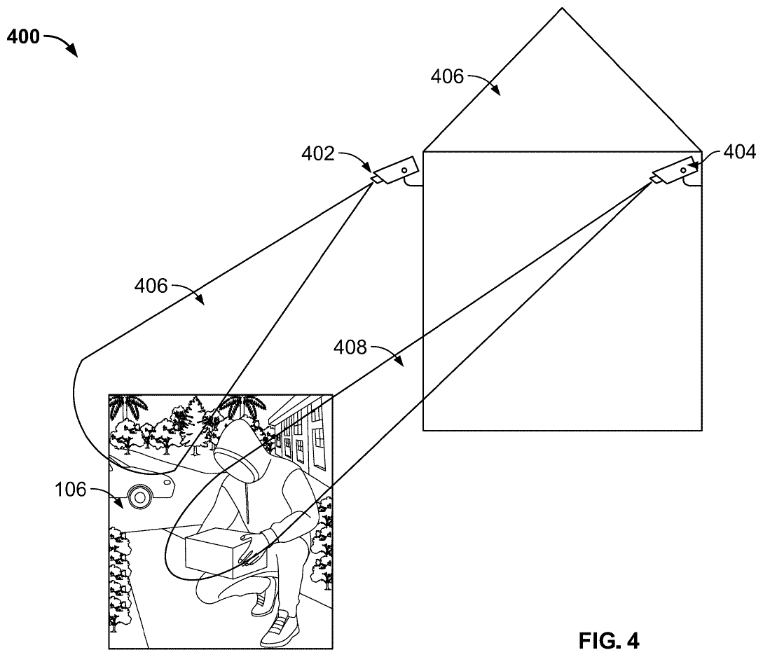

FIG. 4 is an illustrative scenario 400 which shows how a security system may cause different capturing devices to capture media at different resolutions, in accordance with some embodiments of the disclosure. A home security system application may include one or several capturing devices. In scenario 400, capturing device 402 and capturing device 404 may both be available for capturing media. Capturing devices 402-404 may be part of home complex 406. Home complex 406 may have a corresponding home security system application. It should be understood that reference to capturing devices 402-404 may also be in reference to capturing devices 102-104, 208, or 302. Additionally, it should be understood that the home complex 406 is used as an example, and that the same features and concepts described herein may also apply to a business complex, apartment complex, etc., and are not limited to home security use.

A given capturing device may have a different capturing area, different line of sight, different highest available resolution, or another different capability which differentiates it from another capturing device which is also part of the home security system application. For example, capturing device 402 may have capturing area 406, and capturing device 404 may have capturing area 408. Capturing areas 406 and 408 may or may not overlap.

Capturing area 406 and capturing area 408 differ in a number of ways. As one difference, capturing area 406 and capturing area 408 correspond to different lines of sight. As a result, capturing device 402 and capturing device 404 may view different aspects of a particular surveillance area. As another difference, capturing area 406 is wider than capturing area 408. As a result, capturing device 402 may be able to capture media with a wider view than capturing device 404.

In a home security system application which includes multiple capturing devices, it may be desirable for different capturing devices to be able to communicate with one another (e.g., for at least the purpose of ensuring that events of high criticality are caught in the highest resolution). For example, if a first capturing device determines or receives an instruction (e.g., via a transmission) that its currently captured media corresponds to an event of high criticality, it may be desirable to transmit an instruction to other capturing devices to capture media in the highest available quality, or to take some other appropriate action (e.g., changing a characteristic corresponding to a camera which is not the first camera). Other capturing devices may receive an instruction to change a wake-up or capturing threshold such that recording in a higher quality is triggered more easily. For example, if capturing devices record at a certain resolution based on a change in thermal signatures, then the change in the thermal signature may only need a slight change to record on higher quality.

In scenario 400, capturing device 404 may determine that an event is occurring within its capturing area 408. Capturing device 402 may not determine that an event is occurring within its capturing area 406, even though capturing area 406 is wider than capturing area 408, because the line of sight of capturing device 402 does not capture an event. Capturing device 404 may hence capture media 106.

As described in connection with FIG. 1, capturing device 402 may receive an indication (e.g., from server 112) that media 106 corresponds to an event of high criticality. As a result of receiving the indication, capturing device 404 (or any other suitable device or medium) may transmit an instruction to capturing device 402 to capture whatever media it can at its highest available resolution and quality. For example, capturing device 404 may receive an indication that media 106 corresponds to an event of high criticality. In response to determining that media 106 corresponds to an event of high criticality, capturing device 404 may transmit an instruction to capturing device 402 to begin capturing media at its highest available resolution. Capturing device 402 captures media in its highest available resolution to ensure that events which may be related to media 106 are captured in a resolution which may be suitable for later review. For example, because media 106 corresponds to a thief stealing a package, capturing device 402 may capture media showing the thief running up to the front door to steal the package.

In some embodiments, a notification may be generated in response to media 106 being captured by capturing device 402 and capturing device 404. In scenario 400, capturing device 404 initially captures media 106. Before capturing device 402 receives an indication to record whatever media it can at its highest available resolution, a summary may have already been generated for whatever media capturing device 404 captured. After capturing device 402 is also able to capture media at a highest available resolution, the initial textual summary which was generated without media captured by capturing device 402 may be updated to include new information from capturing device 402. The updated summary may be more accurate than the initial summary.

In some embodiments, a notification may be generated in response to media 106 being captured by capturing device 402 and capturing device 404 which combines two separate generated summaries. For example, there may be a first summary which was generated based at least in part on the media captured by capturing device 402, and there may be a second summary which was generated based at least in part on the media captured by capturing device 404. Before a notification is generated, aspects from both the first summary and the second summary may be combined into a third summary. The third summary may be more accurate and/or precise in describing captured media than either the first summary or the second summary. For example, with respect to scenario 400, a first summary may be “a man quickly ran up to the front porch,” and a second summary may be “an unknown man is stealing a package.” A third summary, which combines both the first and second summary, may be “an unknown man quickly ran up to the front porch and stole a package.”

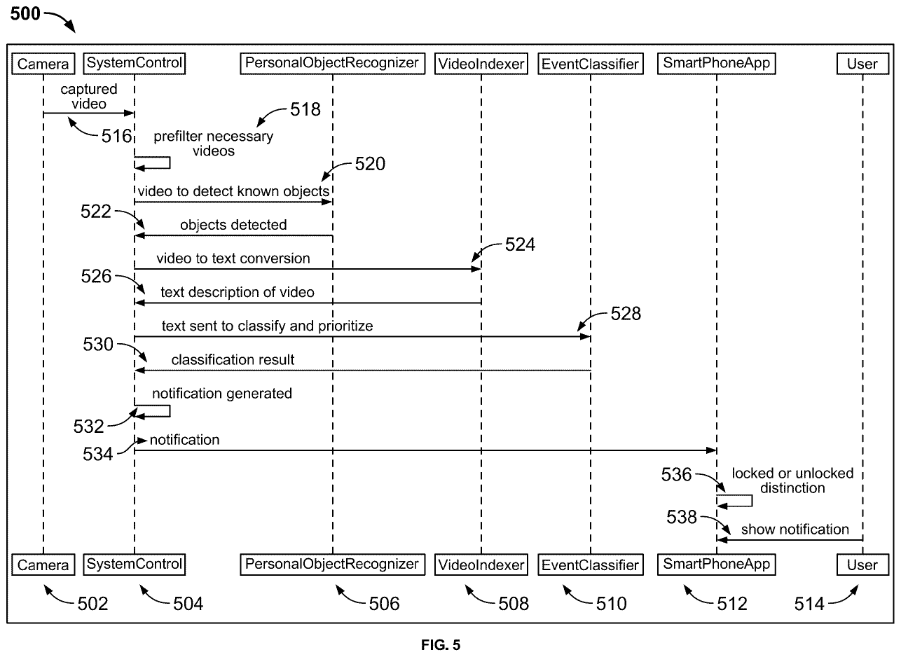

FIG. 5 is an illustrative sequence diagram 500 which shows how notifications may be generated upon the determination that an event is occurring, in accordance with some embodiments of the disclosure. A home security system application may include one or more of the following components: camera 502, system control 504, personal object recognizer 506, video indexer 508, event classifier 510, or smart phone app 512. Camera 502 may be the same as any of capturing devices 102-104, 208, 302, or 402-404. System control 504 may be the same as any general reference to a home security system application or may also be run on any suitable server (e.g., server 112, 212). Personal object recognizer 506, video indexer 508, and event classifier 510 may be in reference to any previous mention as described in connection with FIGS. 1-4. Smart phone app 512 may be a part of device 120 or device 220.

In some embodiments, at 516, camera 502 captures a video. Camera 502 may be triggered to capture a video when it determines that there has been a change according to a heat sensor, motion sensor, or audio sensor, etc.

In some embodiments, at 518, system control 504 filters videos captured by camera 502 at 516 before transmitting them to a medium for analysis. For example, videos may be filtered by resolution, clarity, length, or any other suitable parameter to prevent videos which are of little significance from overloading a database (e.g., database 214, 306). Videos which are determined to be of possible relevance may undergo the same operations as described above in connection with FIG. 3.

In some embodiments, at 520, system control 504 transmits video captured by camera 502 at 516 to personal object recognizer 506. Personal object recognizer 506 may correspond to a subroutine which is run on a server (e.g., server 112, 212). Personal object recognizer 506 may be used to identify if any individuals in video captured by camera 502 are individuals which have been previously recognized.

In some embodiments, at 522, personal object recognizer 520 transmits data to system control 504 which indicates if any individuals were recognized from the video which camera 502 captured. For example, as described in connection with FIG. 2, personal object recognizer 520 may determine that in media 210, individual 202 corresponds to an individual named Mike, individual 204 corresponds to an individual names Steph, and animal 206 corresponds to a dog named Rocky.

In some embodiments, at 524, system control 504 causes a video to text conversion based at least in part on a brief description returned by video indexer 508. At 526, video indexer 508 may return a text description of the video to system control 504. At 524-526, a video to text conversion may also coincide with how textual summary 114 was generated as described above in connection with FIG. 1.

In some embodiments, at 528, system control 504 may cause a textual summary received from 528 to be transmitted to event classifier 510. A textual summary may be transmitted to event 510 to classify how urgent video captured from camera 502 may be. At 530, the classification result determined by event classifier 510 may be sent to system control 504.

In some embodiments, at 532, system control 504 may generate a notification based on video captured by camera 504. A notification may be generated based on a textual summary or can otherwise be modified by personalization settings. At 534, a notification may be transmitted to smart phone app 512.

In some embodiments, at 536, a notification which was generated at 532 may be displayed for some user 514. At 538, the notification may be fully unlocked to showcase more information related to the video which was captured by camera 502.

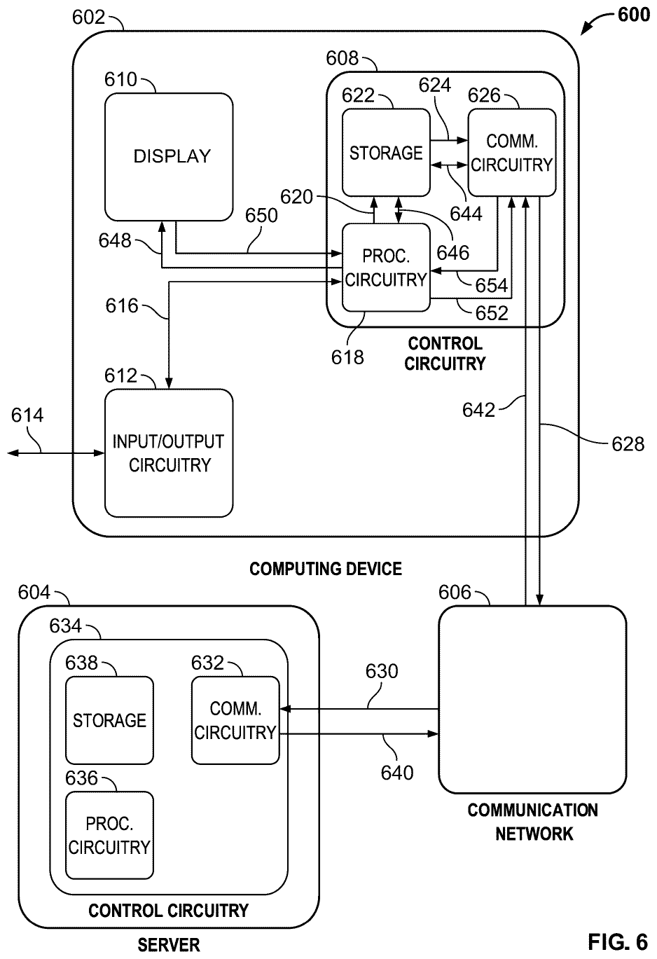

FIG. 6 is a diagram illustrating communication system 600 which may be used in a home security system application, in accordance with some embodiments of the disclosure. A communication system is provided including a computing device, a server, and a communication network. Both the server and the communication network can exist in multiple forms and can connect directly or indirectly. The computing device includes control circuitry, a display, and I/O circuitry. The control circuitry can execute systems, methods, processes, and outputs. Both the computing device and server include control circuitry and storage, which can store content, metadata, data, user profiles, messages, and commands for an application. The computing device communicates with an I/O device and can receive and process user inputs locally or transmit them to the remote server for processing. Both the server and the computing device can transmit and receive content via the communication network or directly, and the processing circuitry receives the user input and converts it to digital signals.

In some embodiments, the system is a distributed network with an edge device (a type of computing device 602), a cloud server (a type of server 604), and an internet of things (IOT) network (a type of communication network 606). Both the edge device and server have microservices and data lakes. The edge device includes a user interface and I/O ports. User interactions can be processed at the edge or in the cloud. The system can transmit and receive digital assets via the IoT network. The edge device communicates with an IoT device and can be various types of smart devices capable of displaying and interacting with digital content. The communication paths in the system can be optimized for latency and bandwidth efficiency.

The system is shown to include computing device 602, server 604, and a communication network 606. It is understood that while a single instance of a component may be shown in the above figures, additional embodiments of the component may be employed. For example, server 604 may include, or may be incorporated in, more than one server. Similarly, communication network 606 may include, or may be incorporated in, more than one communication network. Server 604 is shown communicatively coupled to computing device 602 through communication network 606. Server 604 may be directly communicatively coupled to computing device 602, for example, in a system absent or bypassing communication network 606.

Communication network 606 may include one or more network systems, such as, without limitation, the Internet, LAN, Wi-Fi, wireless, or other network systems suitable for audio processing applications. In still other embodiments, server 604 works in conjunction with one or more components of communication network 606 to implement certain functionality described herein in a distributed or cooperative manner. In other embodiments, computing device 602 works in conjunction with one or more components of communication network 606 or server 604 to implement certain functionality described herein in a distributed or cooperative manner.

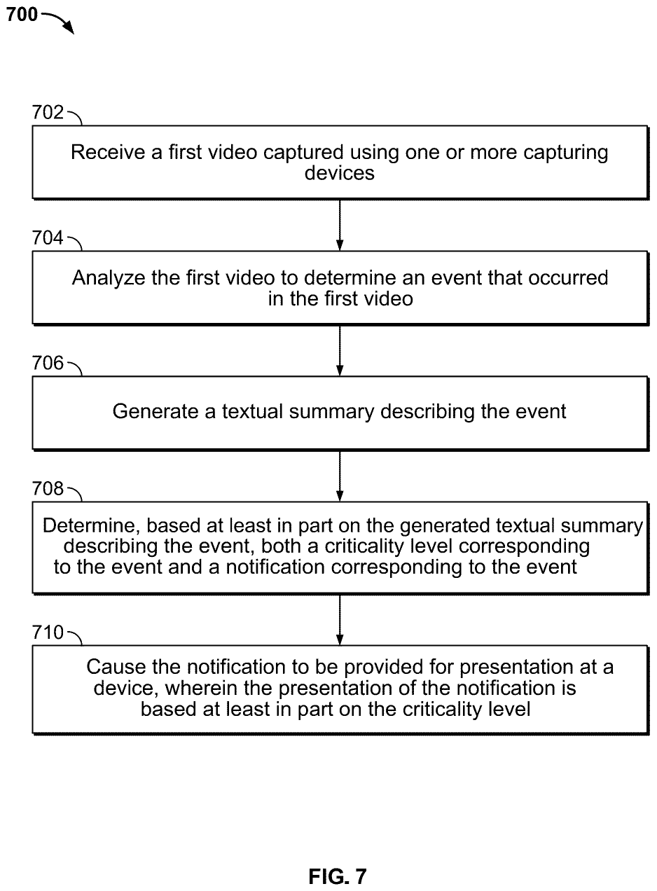

Computing device 602 includes control circuitry 608, display 610 and input/output (I/O) circuitry 612. Control circuitry 608 may be based on any suitable processing circuitry and includes control circuits and memory circuits, which may be disposed on a single integrated circuit or may be discrete components. As referred to herein, processing circuitry should be understood to mean circuitry based on at least one microprocessors, microcontrollers, digital signal processors, programmable logic devices, field-programmable gate arrays (FPGAs), application-specific integrated circuits (ASICs), system-on-chip (SoC), application-specific standard parts (ASSPs), indium phosphide (InP)-based monolithic integration and silicon photonics, non-classical devices, organic semiconductors, compound semiconductors, “More Moore” devices, “More than Moore” devices, cloud-computing devices, combinations of the same, or the like, and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i9 processors) or multiple different processors (e.g., an Intel Core i7 processor and an Intel Core i9 processor). Some control circuits may be implemented in hardware, firmware, or software. Control circuitry 608 in turn includes communication circuitry 626, storage 622 and processing circuitry 618. Either of control circuitry 608 and 634 may be utilized to execute or perform any or all the systems, methods, processes, and outputs of one or more of FIG. 1-6 (above) and FIG. 7 (below), or any combination of steps thereof (e.g., as enabled by processing circuitries 618 and 636, respectively).

In addition to control circuitry 608 and 634, computing device 602 and server 604 may each include storage (storage 622, and storage 638, respectively). Each of storages 622 and 638 may be an electronic storage device. As referred to herein, the phrase “electronic storage device” or “storage device” should be understood to mean any device for storing electronic data, computer software, or firmware, such as random-access memory, read-only memory, cloud-based storage, hard drives, optical drives, digital video disc (DVD) recorders, compact disc (CD) recorders, BLU-RAY disc (BD) recorders, BLU-RAY 3D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each of storage 622 and 638 may be used to store several types of content, metadata, and/or other types of data. Non-volatile memory may also be used (e.g., to launch a boot-up routine and other instructions). Cloud-based storage may be used to supplement storages 622 and 638 or instead of storages 622 and 638. In some embodiments, a user profile and messages corresponding to a chain of communication may be stored in one or more of storages 622 and 638. Each of storages 622 and 638 may be utilized to store commands, for example, such that when each of processing circuitries 618 and 636, respectively, are prompted through control circuitries 608 and 634, respectively. Either of processing circuitries 618 or 636 may execute any of the systems, methods, processes, and outputs of one or more of FIGS. 1-5 (above), or any combination of steps thereof.

In some embodiments, control circuitry 608 and/or 634 executes instructions for an application stored in memory (e.g., storage 622 and/or storage 638). Specifically, control circuitry 608 and/or 634 may be instructed by the application to perform the functions discussed herein. In some embodiments, any action performed by control circuitry 608 and/or 634 may be based on instructions received from the application. For example, the application may be implemented as software or a set of and/or one or more executable instructions that may be stored in storage 622 and/or 638 and executed by control circuitry 608 and/or 634. The application may be a client/server application where only a client application resides on computing device 602, and a server application resides on server 604.

The application may be implemented using any suitable arrangement. For example, it may be a stand-alone application wholly implemented on computing device 602. In such an approach, instructions for the application are stored locally (e.g., in storage 622), and data for use by the application is downloaded on a periodic basis (e.g., from an out-of-band feed, from an Internet resource, or using another suitable approach). Control circuitry 608 may retrieve instructions for the application from storage 622 and process the instructions to perform the functionality described herein. Based on the processed instructions, control circuitry 608 may determine a type of action to perform based at least in part on input received from I/O circuitry 612 or from communication network 606.

The computing device 602 is configured to communicate with an I/O device (not shown) via the I/O circuitry 612. In some embodiments, the user input 614 is received from the I/O device. A wired and/or wireless connection between the I/O circuitry 612 and the I/O device is provided in some embodiments. The I/O device may be, for example, at least one of a keyboard, a mouse, a touchscreen, a microphone, a scanner, a joystick, a graphics tablet, a monitor, a printer, speakers, headphones, a projector, a headset, a wearable device, a gaming controller, an external hard drive, a USB hard drive, an SD card, a network interface card (NIC), combinations of the same, or the like.

In client/server-based embodiments, control circuitry 608 may include communication circuitry suitable for communicating with an application server (e.g., server 604) or other networks or servers. The instructions for conducting the functionality described herein may be stored on the application server. Communication circuitry may include a cable modem, an Ethernet card, or a wireless modem for communication with other equipment, or any other suitable communication circuitry. Such communication may include the Internet or any other suitable communication networks or paths (e.g., communication network 606). In another example of a client/server-based application, control circuitry 608 runs a web browser that interprets web pages provided by a remote server (e.g., server 604). For example, the remote server may store the instructions for the application in a storage device.

The remote server may process the stored instructions using circuitry (e.g., control circuitry 634) and/or generate displays. Computing device 602 may receive the displays generated by the remote server and may display the content of the displays locally via display 610. For example, display 610 may be utilized to present a string of characters. This way, the processing of the instructions is performed remotely (e.g., by server 604) while the resulting displays, such as the display windows described elsewhere herein, are provided locally on computing device 604. Computing device 602 may receive inputs from the user via input/output circuitry 612 and transmit those inputs to the remote server for processing and generating the corresponding displays.

Alternatively, computing device 602 may receive inputs from the user via input/output circuitry 612 and process and display the received inputs locally, by control circuitry 608 and display 610, respectively. For example, input/output circuitry 612 may correspond to a keyboard and/or a set of and/or one or more speakers/microphones which are used to receive user inputs. Input/output circuitry 612 may also correspond to a communication link between display 610 and control circuitry 608 such that display 610 updates based at least in part on inputs received via input/output circuitry 612 (e.g., simultaneously update what is shown in display 610 based on inputs received by generating corresponding outputs based on instructions stored in memory via a non-transitory, computer-readable medium).

Server 604 and computing device 602 may transmit and receive content and data such as media content via communication network 606. For example, server 604 may be a media content provider, and computing device 602 may be a smart television configured to download or stream media content, such as a live news broadcast, from server 604. Control circuitry 634, 608 may send and receive commands, requests, and other suitable data through communication network 606 using communication circuitry 632, 626, respectively. Alternatively, control circuitry 634, 608 may communicate directly with each other using communication circuitry 632, 626, respectively, avoiding communication network 606.

It is understood that computing device 602 is not limited to the embodiments and methods shown and described herein. In nonlimiting examples, computing device 602 may be a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a handheld computer, a stationary telephone, a personal digital assistant (PDA), a mobile telephone, a portable video player, a portable music player, a portable gaming machine, a smartphone, or any other device, computing equipment, or wireless device, and/or combination of the same, capable of suitably displaying and manipulating media content.

Computing device 602 receives user input 614 at input/output circuitry 612. For example, computing device 602 may receive a user input such as a user swipe or user touch. It is understood that computing device 602 is not limited to the embodiments and methods shown and described herein.

User input 614 may be received from a user selection-capturing interface that is separate from device 602, such as a remote-control device, trackpad, or any other suitable user movement-sensitive, audio-sensitive or capture devices, or as part of device 602, such as a touchscreen of display 610. Transmission of user input 614 to computing device 602 may be accomplished using a wired connection, such as an audio cable, USB cable, ethernet cable and the like attached to a corresponding input port at a local device, or may be accomplished using a wireless connection, such as Bluetooth, Wi-Fi, WiMAX, GSM, UTMS, CDMA, TDMA, 8G, 4G, 4G LTE, 5G, NearLink, ultra-wideband technology, or any other suitable wireless transmission protocol. Input/output circuitry 612 may include a physical input port such as a 12.5 mm (0.4921 inch) audio jack, RCA audio jack, USB port, ethernet port, or any other suitable connection for receiving audio over a wired connection or may include a wireless receiver configured to receive data via Bluetooth, Wi-Fi, WiMAX, GSM, UTMS, CDMA, TDMA, 3G, 4G, 4G LTE, 5G, NearLink, ultra-wideband technology, or other wireless transmission protocols.

Processing circuitry 618 may receive user input 614 from input/output circuitry 612 using communication path 616. Processing circuitry 618 may convert or translate the received user input 614 that may be in the form of audio data, visual data, gestures, or movement to digital signals. In some embodiments, input/output circuitry 612 performs the translation to digital signals. In some embodiments, processing circuitry 618 (or processing circuitry 636, as the case may be) conducts disclosed processes and methods.

Processing circuitry 618 may provide requests to storage 622 by communication path 620. Storage 622 may provide requested information to processing circuitry 618 by communication path 646. Storage 622 may transfer a request for information to communication circuitry 626 which may translate or encode the request for information to a format receivable by communication network 606 before transferring the request for information by communication path 628. Communication network 606 may forward the translated or encoded request for information to communication circuitry 632, by communication path 630.

At communication circuitry 632, the translated or encoded request for information, received through communication path 630, is translated or decoded for processing circuitry 636, which will provide a response to the request for information based on information available through control circuitry 634 or storage 638, or a combination thereof. The response to the request for information is then provided back to communication network 606 by communication path 640 in an encoded or translated format such that communication network 606 forwards the encoded or translated response back to communication circuitry 626 by communication path 642.

At communication circuitry 626, the encoded or translated response to the request for information may be provided directly back to processing circuitry 618 by communication path 654 or may be provided to storage 622 through communication path 644, which then provides the information to processing circuitry 618 by communication path 646. Processing circuitry 618 may also provide a request for information directly to communication circuitry 626 through communication path 652, where storage 622 responds to an information request (provided through communication path 620 or 644) by communication path 66 or 646 that storage 622 does not contain information pertaining to the request from processing circuitry 618.

Processing circuitry 618 may process the response to the request received through communication paths 646 or 654 and may provide instructions to display 610 for a notification to be provided to the users through communication path 648. Display 610 may incorporate a timer for providing the notification or may rely on inputs through input/output circuitry 612 from the user, which are forwarded through processing circuitry 618 through communication path 648, to determine how long or in what format to provide the notification. When display 610 determines the display has been completed, a notification may be provided to processing circuitry 618 through communication path 650.

The communication paths between computing device 602, server 604, communication network 606, and all subcomponents depicted are examples and may be modified to reduce processing time or enhance processing capabilities for each step in the processes disclosed herein by one skilled in the art.

FIG. 7 is an illustrative flowchart 700 outlining the steps for a method which provides a notification for an event, in accordance with some embodiments of the disclosure.

At 702, a home security system application may receive a first video captured using one or more capturing devices. The one or more capturing devices may be the same as any of the capturing devices shown in FIGS. 1-5.

At 704, a home security system application may analyze the first video to determine an event that occurred in the first video. The analyses which occur may be same as the analyses described above in connection with FIGS. 1-5. For example, the analyses may include results from a personal object recognizer, video indexer, or event classifier. In some embodiments, analyzing the first video may include determining a feature in the first video, wherein the feature corresponds to one or more of a person type, an object type, a company type, a profession type, an event type, an action type, a historical event type, or an alert associated with the first video. A home security system application may generate a textual summary which may be based at least in part on the feature. In some embodiments, a home security system application may receive feedback information, wherein the feedback information comprises information indicative of an accuracy of one or more of a textual summary, a criticality level, or a feature. The feedback information may be analyzed in a later analysis of a second received video.

At 706, a home security system application may generate a textual summary describing the event.

At 708, a home security system application may determine, based at least in part on the generated textual summary describing the event, both a criticality level corresponding to the event and a notification corresponding to the event. determine a criticality level corresponding to the event, wherein the criticality level is based at least in part on one or more of the textual summary or information corresponding to the event. In some embodiments, a home security system application may determine that the first video corresponds to a high criticality level, wherein the high criticality level is a type of criticality level. A home security system application may annotate the first video with a flag, wherein the flag indicates to not delete the first video. In some embodiments, based on determining that the event corresponds to a predetermined event from an external application, a home security system application may determine that the event corresponds to a non-threat. In some embodiments, based on determining that the event corresponds to a routine event, a home security system application may determine that the event corresponds to a non-event. In some embodiments, a home security system application may, based at least in part on the criticality level, determine a resolution quality level for the first video and store the first video at the resolution quality level.

At 710, a home security system application may cause the notification to be provided for presentation at a device, wherein the presentation of the notification is based at least in part on the criticality level. A device may be the same as device 120 or device 220. In some embodiments, a home security system application may determine that a prior notification is generated for display at the device based on a prior event. The home security system application may determine a display order of the notification and the prior notification, wherein the display order is based at least in part on the criticality level corresponding to the event and a second criticality level corresponding to the prior event. The home security system application may transmit to the device information indicative to order the prior notification and the notification based on the display order.

In some embodiments, a home security system application may retrieve a previous video from a server, wherein the previous video was previously captured and corresponds to a previous event. A home security system application may determine a similarity confidence level, wherein the similarity confidence level comprises information indicative of whether the previous event corresponding to the previous video is similar to the event corresponding to the first video. A home security system application may determine that the similarity confidence level exceeds a similarity threshold and, in response to determining that the similarity confidence level exceeds the similarity threshold, delete the previous video from the server.

In some embodiments, a home security system application may determine that the first video was captured using a first capturing device of the one or more capturing devices and transmit an indication to a second capturing device of the one or more capturing devices, the indication causing the second capturing device to capture video at a high resolution, wherein the second capturing device is from the one or more capturing devices.

The actions and descriptions of FIG. 7 may be used with any other embodiment of this disclosure. In addition, the actions and descriptions described in relation to FIG. 7 may be done in suitable alternative orders or in parallel to further the purposes of this disclosure.

Furthermore, in some embodiments, events and operations described in FIGS. 1-7 need not be applicable to home security systems. For example, events and operations described in FIGS. 1-7 may be applicable to general business establishment security systems, hotel security systems, or any suitable area such that a security system may be desirable.

The processes described above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A computer implemented method comprising:
receiving a first video captured using one or more capturing devices;
analyzing the first video to determine an event that occurred in the first video;
generating a textual summary describing the event;
determining, based at least in part on the generated textual summary describing the event, both a criticality level corresponding to the event and a notification corresponding to the event; and
causing the notification to be provided for presentation at a device, wherein the presentation of the notification is based at least in part on the criticality level.

2. The method of claim 1, further comprising:
determining a feature in the first video, wherein the feature corresponds to one or more of a person type, an object type, a company type, a profession type, an event type, an action type, a historical event type, or an alert associated with the first video; wherein:
generating the textual summary is based at least in part on the feature.

3. The method of claim 2, further comprising:
receiving feedback information, wherein the feedback information comprises information indicative of an accuracy of one or more of the textual summary, the criticality level, or the feature; and
analyzing the feedback information in a later analysis of a second received video.

4. The method of claim 1, further comprising:
based at least in part on the criticality level, determining a resolution quality level for the first video; and
storing the first video at the resolution quality level.

5. The method of claim 1, further comprising:
retrieving a previous video from a server, wherein the previous video was previously captured and corresponds to a previous event;
determining a similarity confidence level, wherein the similarity confidence level comprises information indicative of whether the previous event corresponding to the previous video is similar to the event corresponding to the first video;
determining that the similarity confidence level exceeds a similarity threshold; and
based at least in part on determining that the similarity confidence level exceeds the similarity threshold, deleting the previous video from the server.

6. The method of claim 1, further comprising:
determining that the first video corresponds to a high criticality level, wherein the high criticality level is a type of criticality level; and
annotating the first video with a flag, wherein the flag indicates to not delete the first video.

7. The method of claim 1, further comprising:
determining that the first video was captured using a first capturing device of the one or more capturing devices; and
transmitting an indication to a second capturing device of the one or more capturing devices, the indication causing the second capturing device to capture video at a high resolution, wherein:
the second capturing device is from the one or more capturing devices.

8. The method of claim 1, wherein causing the notification to be provided for presentation at the device further comprises:
determining that a prior notification is generated for display at the device based on a prior event;
determining a display order of the notification and the prior notification, wherein the display order is based at least in part on the criticality level corresponding to the event and a second criticality level corresponding to the prior event; and
transmitting to the device information indicative to order the prior notification and the notification based on the display order.

9. The method of claim 1, wherein determining the criticality level corresponding to the event further comprises:
based on determining that the event corresponds to a predetermined event from an external application, determining that the event corresponds to a non-threat.

10. The method of claim 1, wherein determining the criticality level corresponding to the event further comprises:
based on determining that the event corresponds to a routine event, determining that the event corresponds to a non-threat.

11. A system comprising:
memory; and
control security configured to:
receive a first video captured using one or more capturing devices;
analyze the first video to determine an event that occurred in the first video;
generate a textual summary describing the event;
determine, based at least in part on the generated textual summary describing the event, both a criticality level corresponding to the event and a notification corresponding to the event and
cause the notification to be provided for presentation at a device, wherein the presentation of the notification is based at least in part on the criticality level.

12. The system of claim 11, wherein the control circuitry is further configured to:
determine a feature in the first video, wherein the feature corresponds to one or more of a person type, an object type, a company type, a profession type, an event type, an action type, a historical event type, or an alert associated with the first video; wherein:
generating the textual summary is based at least in part on the feature.

13. The system of claim 12, wherein the control circuitry is further configured to:
receive feedback information, wherein the feedback information comprises information indicative of an accuracy of one or more of the textual summary, the criticality level, or the feature; and
analyze the feedback information in a later analysis of a second received video.

14. The system of claim 11, wherein the control circuitry is further configured to:
based at least in part on the criticality level, determine a resolution quality level for the first video; and
store the first video at the resolution quality level.

15. The system of claim 11, wherein the control circuitry is further configured to:
retrieve a previous video from a server, wherein the previous video was previously captured and corresponds to a previous event;
determine a similarity confidence level, wherein the similarity confidence level comprises information indicative of whether the previous event corresponding to the previous video is similar to the event corresponding to the first video;
determine that the similarity confidence level exceeds a similarity threshold; and
in response to determining that the similarity confidence level exceeds the similarity threshold, delete the previous video from the server.

16. The system of claim 11, wherein the control circuitry is further configured to:
determine that the first video corresponds to a high criticality level, wherein the high criticality level is a type of criticality level; and
annotate the first video with a flag, wherein the flag indicates to not delete the first video.

17. The system of claim 11, wherein the control circuitry is further configured to:
determine that the first video was captured using a first capturing device of the one or more capturing devices; and
transmit an indication to a second capturing device of the one or more capturing devices, the indication causing the second capturing device to capture video at a high resolution, wherein:
the second capturing device is from the one or more capturing devices.

18. The system of claim 11, wherein, when causing the notification to be provided for presentation at a device, the control circuitry is further configured to:
determine that a prior notification is generated for display at the device based on a prior event;
determine a display order of the notification and the prior notification, wherein the display order is based at least in part on the criticality level corresponding to the event and a second criticality level corresponding to the prior event; and
transmit to the device information indicative to order the prior notification and the notification based on the display order.

19. The system of claim 11, wherein, when determining the criticality level corresponding to the event, the control circuitry is further configured to:
based on determining that the event corresponds to a predetermined event from an external application, determine that the event corresponds to a non-threat.

20. The system of claim 11, wherein, when determining the criticality level corresponding to the event, the control circuitry is further configured to:
based on determining that the event corresponds to a routine event, determine that the event corresponds to a non-threat.

21-50. (canceled)
